(19) United States
(12) Patent Application Publication
(10) Pub. No.: US 2026/0327153 A1
(43) Pub. Date: Oct. 22, 2026

(54) CONSTRUCTION PRODUCT

(71) Applicant: ADAPTAVATE Limited, Bristol (GB)

(72) Inventors: Jeffrey Ive, Bristol (GB); Thomas Robinson, Bristol (GB); Nicholas Costa Ford, Bristol (GB)

(21) Appl. No.: 19/122,804

(22) PCT Filed: Oct. 20, 2023
(86) PCT No.: PCT/GB2023/052754

§ 371 Date: Apr. 21, 2025

(30) Foreign Application Priority Data
Oct. 21, 2022 (GB) 2215631.9

(51) Int. Cl. C04B 40/02; B28B 19/00; B32B 13/08; C04B 18/10; C04B 28/10; C04B 111/00

(52) U.S. Cl. CPC C04B 40/0231; B28B 19/0092; B32B 13/08; C04B 18/10; C04B 28/10; C04B 40/0281; C04B 2111/00019; C04B 2111/00612

(57) ABSTRACT

A construction product comprising an accelerated carbonation-cured mixture and a method of manufacturing the construction product is provided. The method comprises: producing a mixture of bio-aggregate and a binder, the binder comprising an alkaline earth metal oxide or alkaline earth metal hydroxide; and exposing the mixture to a carbon dioxide containing feed stream for accelerated carbonation of the mixture. The method further comprises: forming the mixture into a predetermined geometric shape; and providing a planar lining material on one or more outer faces of the predetermined geometric shape.

### FIELD OF THE INVENTION

Embodiments of the present invention relate to construction products. In particular, they relate to low-carbon or carbon-negative construction products.

### BACKGROUND TO THE INVENTION

The Intergovernmental Panel on Climate Change (IPCC) published a report in 2018 detailing the actions which Governments need to take in order to meet the target of ensuring that the global temperature rise is no more than 1.5° C. above pre-industrial levels. The IPCC report stated that in order to meet this target, global carbon dioxide emissions would need to reach net zero by the middle of the Century. Transitional changes towards lower greenhouse gas emissions are underway, however in order to limit warming to 1.5° C., it is considered that a rapid escalation in the scale and pace of transition would be required. It is however challenging for some industries to achieve net zero. The IPCC has suggested that a technique known as Carbon Dioxide Removal (CDR), in which carbon dioxide is removed from the atmosphere, could help to limit warming. Conventional construction materials release greenhouse gases during one or more of: the manufacturing process, during transportation, during customer use and end of life. The manufacture of most products involves the generation of greenhouse gas emissions by using raw materials which have been mined or manufactured using fossil fuels and/or by transporting the product and/or reagents.

There is therefore a need for a construction product which is capable of removing carbon dioxide from the atmosphere.

### BRIEF DESCRIPTION

The invention is as defined in the appended independent claims. The present invention provides construction products and methods for manufacturing the products. The construction products, and the associated methods of manufacture of the products, of the present invention may utilise accelerated carbonation and/or pyrolyzed feedstock (for example pyrolyzed bio-aggregate).

The construction products may be low-carbon or carbon-negative construction products.

The term “low-carbon” is used herein to refer to a product which, when manufactured, causes a smaller amount of carbon dioxide to be released into the atmosphere than a corresponding conventional product.

The term “carbon-negative” is used herein to refer to a product which removes a greater amount of carbon dioxide from the atmosphere than enters the atmosphere during manufacture of the product.

The product of the present invention described herein utilises carbon as a resource (for example as carbon dioxide during accelerated carbonation and/or as pyrolyzed bio-aggregate) and as a result the manufacture of the product may reduce carbon dioxide in the atmosphere.

The construction product of the present invention described herein may have a net effect of removing carbon dioxide from the atmosphere (when measured from resource extraction until completion i.e., at the factory gate). The construction product of the present invention may therefore be used to mitigate global warming.

The construction product of the present invention is preferably composed of natural materials. Preferably, the construction product is composed of at least 80 wt. %, preferably at least 90 wt. %, preferably at least 95 wt. %, for example about 99 wt. % of natural materials compared to the total weight of the mixture. In some embodiments, the construction product consists entirely of natural materials.

The term “bio-aggregate” is used herein to refer to granulates formed from plant material. Each granulate within the bio-aggregate has a maximum particle size, which is used herein to refer to the largest dimension of the granulate. The bio-aggregate may be formed from any suitable part of a plant. Preferably, the bio-aggregate is formed from the stem of a plant. The bio-aggregate may for example comprise milled bio-aggregate. The bio-aggregate may be milled using any conventional milling mechanism, such as for example a knife, hammer, rotary or ball mill. The milled bio-aggregate may be passed through a screen or sieve having predetermined pores to enable milled bio-aggregate having predetermined dimensions to pass therethrough. The bio-aggregate is preferably formed from chemically unprocessed plant material. The term “chemically unprocessed” is used herein to refer to plant material in which the cell architecture within the plant material remains unchanged.

The bio-aggregate may be provided by a broad range of plant types. The construction product may be prepared from low value, readily (and preferably locally) available, highly voluminous plant material. Furthermore, the construction product of the present invention may be produced on a large scale at low cost with low associated energy costs.

Suitable plant material for use as the bio-aggregate may include for example perennial plant(s), such as for example processed perennial plant(s) and/or by-products of processing of perennials plant(s). The bio-aggregate may comprise softwood or hardwood. Suitable plant material for use as the bio-aggregate includes both softwood and hardwood timber particles.

The bio-aggregate is preferably an agricultural product or by-product, for example a farm crop, farm crop by-product, food crop or food crop by-product. The bio-aggregate is preferably selected from one or more of: maize; wheat (for example common wheat (Triticum aestivum); rice; barley; millet; grasses (for example horsetail); rice husk; straw; squash; pumpkin; watermelon; cucumber; melon; hops; cannabis; celtis tress; nettles; wildflowers; rape straw; algae; seaweed; bamboo; rapeseed (Brassica napus); barley (Hordeum vulgare); oats (Avena sativa); flax; rice straw; corn straw; giant miscanthus (Miscanthus giganteus); sugarcane bagasse; sisal straw; hemp; or any combination thereof. Preferably, the bio-aggregate consists of one or more moderate silica content-containing plants, and/or one or more high silica content-containing plants.

The bio-aggregate preferably comprises at least one moderate (preferably a high) silica content-containing plant. Preferably, the at least one moderate (preferably high) silica content-containing plant comprises a silica content of equal to or above 2%, for example a silica content of equal to or above 4%.

The moderate to high silica content of the plant(s) forming the bio-aggregate is able to react with alkaline earth metals (for example calcium) within the binder to form a strong, durable crystalline, alkaline earth metal silica hydrate, for example calcium silica hydrate. This crystalline structure has been found to be the same as the crystalline structure of calcium silica hydrate found within cement. The alkaline earth metal silica hydrate (for example calcium silica hydrate) formed has been found to provide a pozzolanic effect which improves the strength of the product through the use of bio-aggregate. The increased strength of the construction product of the present invention therefore reduces the reliance on high carbon intensity binders (such as cement). Furthermore, the construction product of the present invention has increased strength without requiring the use of other mineral based pozzolans such as metakaolin and silica fume or requiring a lower amount of such mineral based pozzolans.

Preferably, the bio-aggregate comprises one or more high silica content-containing plants, selected for example from one or more of: the Poaceae, Equisetaceae, and/or Cyperaceae families or any combination thereof; and/or one or more moderate silica content-containing plants, selected for example from one or more of the Cucurbitales, Urticales and/or Commelinaceae families, or any combination thereof. The Poaceae plant family is the most economically important plant family, providing staple foods from domesticated cereal crops as well as feed for meat producing animals. The Poaceae plant family provides, through direct human consumption, just over one-half (51%) of all dietary energy. Rice provides 20%, wheat provides 20%, maize (corn) provides 5.5%, and other grains provide 6% of all dietary energy. The Poaceae plant family includes for example maize, wheat, rice, barley, and millet

Some members of the Poaceae plant family, such as for example bamboo, thatch and straw, are used as building materials. Other members of the Poaceae family, such as for example maize, can provide a source of biofuel.

The Equisetaceae family includes grasses such as for example Horsetail. The Cyperaceae family comprises 5,500 known species in about 90 genera. Examples include rice husk and straw.

The Cucurbitales family, such as for example the Cucurbitaceae (gourd) family, includes food species, such as for example squash (from Cucurbita), pumpkin (from Cucurbita), watermelon (Citrullus vulgaris), cucumber (Cucumis), and melon (Cucumis).

The Urticales family includes Cannabaceae which are farmed and include for example hops, cannabis, and Celtis Tress (such as for example Pteroceltis). Celtis Tress (such as for example Pteroceltis) is known for high end rice paper. Cannabis is inclusive of the industrial hemp plant but also variants that are high in tetrahydrocannabinol (THC), and other cannabinoids, most commonly Cannabidiol CBD as these are being farmed with increasing frequency for recreational and medicinal use.

The Urticales family also includes Urticaceae which includes for example common nettles.

The Commelinaceae family includes for example wildflowers.

The bio-aggregate may comprise organic by-products of food processing. The organic by-products of food or drink processing may be selected from nutshells, fruit stones, coffee grounds, spent hops, spent grain, or pomace.

The term “pyrolysis” is used herein to thermal decomposition of bio-aggregate or feedstock in the absence or near absence of oxygen. Pyrolysis is usually carried out at temperatures at or above 500 °C to enable enough heat to be provided to deconstruct biopolymers within the bio-aggregate or feedstock. As no oxygen (or almost no oxygen) is present, combustion of the bio-aggregate or feedstock does not occur and the matter thermally decomposes into biochar and combustible gases. The combustible gases may be condensed to provide a combustible liquid referred to as pyrolysis oil or bio-oil. Gases generated during pyrolysis such as carbon dioxide, carbon monoxide and light hydrocarbons may be combusted to provide heat for the process. Pyrolysis conditions such as the temperature and heating rate may vary. Variations in the pyrolysis conditions may alter the yields of pyrolyzed bio-aggregate or feedstock obtained. In some embodiments, slow heating rates are used to increase the production of pyrolyzed bio-aggregate or feedstock. In some embodiments, the pyrolysis of the bio-aggregate or feedstock may be self-sufficient by utilising the combustible gases obtained during the process to provide the thermal energy.

According to a first aspect of the disclosure there is provided a construction product is described which comprises an accelerated carbonation-cured mixture of:
i) a binder comprising at least one of: an alkaline earth metal oxide and/or alkaline earth metal hydroxide; and
ii) bio-aggregate.

In some examples, the construction product is an internal board, and planar lining material is provided on one or both outer faces of the mixture. The internal board may be an internal lining board.

The binder and/or the bio-aggregate may be as described above.

The binder is preferably selected from one or more of: alkaline earth metal oxides (for example magnesium oxide); alkaline earth metal hydroxides (for example calcium hydroxide); cement (for example one or more of: Ordinary Portland Cement, White Cement, calcium aluminate cement, natural cement, or any combination thereof); lime (for example one or more of: lime oxide, hydrated lime, natural hydraulic lime, or any combination thereof); pozzolanic elements (for example one or more of: metakaolin, silica fume, fly ash, or any combination thereof), or any combination thereof.

Preferably, the binder comprises one or more of: alkaline earth metal oxide and/or alkaline earth metal hydroxide.

Preferably, the binder comprises hydrated lime, for example natural hydraulic lime.

The ratio of the amount of bio-aggregate (wt. %) to the amount of binder (wt. %) within the mixture is preferably at least 1:10, preferably at least 1:8, for example at least 1:6. The ratio of the amount of bio-aggregate (wt. %) to the amount of binder (wt. %) within the mixture is preferably no more than 1:1.5, preferably no more than 1:2, for example no more than 1:3. The ratio of the amount of bio-aggregate (wt. %) to the amount of binder (wt. %) within the mixture is preferably between 1:10 to 1:1.5, preferably between 1:8 and 1:2, preferably between 1:6 and 1:3.

The maximum particle size of granulates within the bio-aggregate preferably is no greater than about 100 mm, more preferably no greater than about 70 mm, more preferably no greater than about 50 mm, more preferably no greater than 40 mm, for example no greater than 30 mm.

The maximum particle size of the granulates of the bio-aggregate preferably is at least about 0.1 mm, more preferably at least about 0.15 mm, more preferably at least about 0.2 mm, for example at least about 0.25 mm.

The range of maximum particle sizes of the granulates of the bio-aggregate is preferably within the range of between 0.1 mm and 100 mm, preferably in the range of between 0.1 mm and 70 mm, preferably in the range of between 0.1 mm and 50 mm.

The profile of the distribution of maximum particle sizes of the granulates of the bio-aggregate is of importance to both the manufacturing and structural performance of the resultant product.

Particle size distribution is conventionally defined by the method by which it is determined.

One suitable method is sieve analysis, where powder is separated on sieves of different sizes. The maximum particle sizes and particle size distributions described herein may be determined by sieve analysis.

The particle size distribution is therefore determined in terms of discrete size ranges based on the sizes of sieves used. The particle size distribution may be presented in cumulative form.

In some embodiments, the bio-aggregate comprises a predetermined particle size distribution ranging from a minimum value of a maximum particle size to a maximum value of a maximum particle size.

In some embodiments, the cumulative particle size distribution function of the bio-aggregate, when determined from the highest value of maximum particle size to the lowest value of maximum particle size, is substantially S-shaped.

In some embodiments, the bio-aggregate may be fine, and may have a maximum particle size of substantially 5 mm. The bio-aggregate may have a relatively narrow particle size distribution. In some embodiments, over 50% of the bio-aggregate may have a particle size of between 1 mm and 4 mm, and over 30% may have a particle size of less than 1 mm. Over 50% of the bio-aggregate may have a maximum particle size of between 1 mm and 4 mm. Over 30% of the bio-aggregate may have a maximum particle size of less than 1 mm.

In some embodiments, at least the majority of the particles may have a maximum particle size of less than one third of the construction product thickness, for example where the construction product is manufactured as a planar sheet, such as an internal lining board/plasterboard (as measured between opposing surfaces of the mixture optionally lined with planar lining material). In some embodiments, substantially none of the particles may have a maximum particle size of greater than one third of the construction product thickness, for example where the construction product is manufactured as a planar sheet, such as an internal lining board/plasterboard (as measured between opposing surfaces of the mixture optionally lined with planar lining material).

In some embodiments, the bio-aggregate comprises a first bio-aggregate portion having a fine particle size (for example having a maximum particle size of no more than 5 mm) to provide for increased reactivity to form the crystalline calcium silica hydrate. The bio-aggregate preferably further comprises a second bio-aggregate portion having a larger particle size than the first bio-aggregate portion (for example, the second bio-aggregate portion comprises granulates having a maximum particle size of no more than 100 mm) to provide a product with reduced density and improved thermal and/or hygroscopic properties. The first and second bio-aggregate portions may be provided by the same plant or by different plants.

The bio-aggregate is preferably pyrolyzed thereby enabling carbon to be sequestered from the atmosphere and locked within the resultant pyrolyzed biochar indefinitely. Further, pyrolysis of the bio-aggregate increases the density of the carbon within the construction product. Pyrolyzed bio-aggregate particles are hydrophobic and therefore provide for improved contact between binder and the bio-aggregate resulting in improved mechanical strength of the resultant construction product. Pyrolysis of the bio-aggregate chemically alters the structure of the bio-aggregate resulting in increased mechanical properties, inclusive of for example compressive modulus and/or strength and flexural modulus/strength of the bio-aggregate and then in turn the resultant construction product. Pyrolysis of bio-aggregate also provides a source of bio-oil and/or bio-gas for further downstream processing.

Pyrolysis of the bio-aggregate preferably produces pyrolyzed bio-aggregate particles with a narrower particle size distribution compared to non-pyrolyzed bio-aggregate. Bio-aggregate is highly siliceous and has a fibrous nature, which may make it difficult/non cost effective to grind to a small particle size. Pyrolyzed bio-aggregate, due in part to the high carbon content, is far more brittle in character and therefore easier to grind.

Pyrolyzed bio-aggregate particles have improved size regularity which results in a construction product with improved surface finish due to a more regular particle size distribution. The improved surface finish translates to an improved edge definition leading to more efficient installation of the resultant construction product.

Pyrolysis of the bio-aggregate preferably produces pyrolyzed bio-aggregate particles with a reduced water content (preferably a uniform water content).

Pyrolyzed bio-aggregate has an improved ability to sequester volatile organic components (VOCs) out of the atmosphere due to the ionic nature of the particle surface and the increased surface area compared to non-pyrolyzed particles.

In some embodiments, the negative carbon construction product may comprise inert, non-biodegradable pyrolyzed bio-aggregate which has indefinitely sequestered biogenic carbon within the pyrolyzed bio-aggregate.

In some embodiments, the bio-aggregate (or pyrolyzed bio-aggregate) has a silica content of at least 2 wt. %, preferably at least 4 wt. %. The silica within the bio-aggregate (or pyrolyzed bio-aggregate) is able to react with the binder to form alkaline earth metal silica hydrate (for example calcium silica hydrate) providing a pozzolanic effect which has been found to improve the strength of the resultant construction product. The present invention therefore reduces the reliance of the product on the presence of additional high carbon intensity binders (such as cement) and can remove the requirement for other mineral based pozzolans such as metakaolin and silica fume.

The mixture may further comprise one or more additives selected from: viscosity modifying agents; and/or coupling agents; and/or water retention agents; or any combination thereof. The one or more additives may comprise one or more carbohydrates, for example polysaccharides, such as for example methylated cellulose ether. The one or more additives are preferably plant-derived. The mixture may further comprise an air entraining agent such as lignin sulfonate.

The mixture may further comprise a plasticizer. The plasticizer may be present in the mixture in an amount of up to 2 wt. % of the weight of the binder. Preferably the plasticizer is present in the mixture in an amount between 0.5 wt. % and 1.5 wt. % of the weight of the binder.

The construction product may be an internal board, such as an internal lining board, an insulation board, or an acoustic panel. The construction product may, for example, be an internal lining board, an insulation board, an acoustic panel, a tile, a block or a lintel. The construction product may for example be a moulded construction product (e.g., a lining board, an insulation board, an acoustic panel, a tile, a block or a lintel formed at least in part by moulding). Water may be added to the mixture prior to moulding. The moulded construction product may be formed using extrusion moulding, for instance by extruding through a die. The moulded construction product may be formed using continuous extrusion moulding, The die could for instance be one or more rollers through which the mixture is continuously extruded. The construction product may be formed by continuously extruding the mixture on a conveyor, wherein the mixture is provided on the conveyor, and the die is defined by a gap between the conveyor and a roller. In some examples the planar lining material is applied to an outer face of the mixture by the roller during continuous extrusion. The die may also include a static (i.e. non-rolling) element in conjunction with the roller. In other examples, the construction product might be cast or 3D-printed. If, for example, the construction product is an internal lining board (or another type of internal board such as an insulation board or an acoustic panel), the construction product may comprise an accelerated carbonation-cured mixture of the binder and bio-aggregate provided on planar lining material, preferably between two opposed sheets of planar lining material. The planar lining material is preferably provided on one or both outer faces of the mixture, for example moulded mixture.

In some embodiments the planar lining material is paper. In some examples, the paper has a weight of up to 250 gsm. The paper may have a weight of at least 150 gsm. The paper may have a weight of between 170 gsm and 200 gsm and may be a recycled paper.

The mixture may include a cellulose adhesive, which may be methyl cellulose. A cellulose adhesive may be used to adhere the lining material to the remainder of the materials. The cellulose adhesive may contain between 1 and 2% cellulose in water. The cellulose may be methyl cellulose.

The density of the construction product may be at least 400 kg/m³. Preferably the density of the construction product is at least at least 500 kg/m³, such as 650 kg/m³. The density of the construction product may be up to 1000 kg/m³. Preferably the density of the construction product is up to 700 kg/m³. The density of the construction product may be between 500 kg/m³ and 750 kg/m³, such as 650 kg/m³. Preferably, the density of the construction product is between 500 kg/m³ and 700 kg/m³.

The construction product thickness, for example when manufactured as a planar sheet (for example plasterboard) (as measured between opposing surfaces of the mixture optionally lined with planar lining material) may be at least 5 mm, preferably at least 9 mm, for example about 10 mm. The construction product thickness may be no more than 50 mm. Preferably, the construction product thickness is between 5 mm and 50 mm, preferably between 9 mm and 50 mm, for example between 10 mm and 50 mm. Most preferably, the construction product thickness is between 8 mm and 15 mm.

In some examples, the construction product is made from a combination of different board types. For instance, an internal face of the construction product may be an insulation board, and an external face of the construction product may be made from an internal lining board. The internal lining board may be thinner and denser than the insulation board.

In some alternative examples, the construction product may be a plaster or a render formed by the mixture described herein. The plaster may be an internal plaster that is for use on the internal walls of a building. The render may be an external render that is for use on the external walls of a building.

In such examples, the plaster or render is not cured during production (using accelerated carbonation curing or otherwise). Instead, the plaster/render is cured on-site after being applied to an internal wall or an external wall. The plaster or render may, for example, be a dry particulate mixture (e.g., a dry mortar product) to which water is added on site to enable or cause the plaster/render to cure.

The use of pyrolyzed feedstocks in the construction product may allow a lower amount of water retention agent to be used than would otherwise be the case without pyrolysis, due to the hydrophobic nature of the pyrolyzed feedstock. The water retention agent (which may include complex carbohydrates) may act as a coupling agent between the binder and celluloses present in the feedstock and the lining material (if a lining material is used). Use of a lower amount of water retention agent potentially reduces surface shrinkage, resulting in a more homogenous finish.

The construction product has been found to have improved mechanical properties, such as for example flexural strength, improved compressive strength, improved sheer strength, improve nail pull resistance, and improved ability to accept fastenings, compared to the same construction product which has not been exposed to accelerated carbonation. Such an internal board has been found to have improved planar lining material (for example paper) to composite/mixture bond as a result of accelerated carbonation.

According to a further aspect of the disclosure there is provided a construction product comprising a mixture, wherein the mixture comprises:
i) a binder comprising at least one of: an alkaline earth metal oxide and/or alkaline earth metal hydroxide; and
ii) pyrolyzed feedstock.

In some examples, the feedstock is a bio-aggregate, the construction product is an internal board, and planar lining material is provided on one or both outer faces of the mixture. The internal board may be an internal lining board.

The pyrolyzed feedstock may for example be pyrolyzed bio-aggregate.

The binder and/or the bio-aggregate may be as described above. The mixture may further comprise one or more additives as described above.

The binder is selected from one or more of: alkaline earth metal oxides (for example magnesium oxide); alkaline earth metal hydroxides (for example calcium hydroxide); cement (for example one or more of: Ordinary Portland Cement, White Cement, calcium aluminate cement, natural cement, or any combination thereof); lime (for example one or more of: lime oxide, hydrated lime, natural hydraulic lime, or any combination thereof); pozzolanic elements (for example one or more of: metakaolin, silica fume, fly ash, or any combination thereof), or any combination thereof.

Preferably, the binder comprises one or more of: alkaline earth metal oxide and/or alkaline earth metal hydroxide.

Preferably, the binder comprises hydrated lime, for example natural hydraulic lime.

The mixture may include a cellulose adhesive, which may be methyl cellulose.

A cellulose adhesive may be used to adhere the lining material to the remainder of the materials. The cellulose adhesive may contain up to 2 wt. % cellulose in water. The cellulose adhesive may contain between 1 and 2 wt. % cellulose in water. The cellulose may be methyl cellulose.

The pyrolyzed feedstock sequesters carbon from the atmosphere and may lock the sequestered carbon within the resultant pyrolyzed feedstock indefinitely. As a result, the construction product of the present invention may result in the direct removal and long-term storage of a greater amount of carbon dioxide from the environment than is required to manufacture the product. Further, pyrolysis of the feedstock increases the density of the carbon within the construction product. Pyrolyzed feedstock particles are hydrophobic and therefore provide for improved contact between binder and the feedstock resulting in improved mechanical strength of the resultant construction product. Pyrolysis of the feedstock chemically and physically alters the structure of the feedstock resulting in increased mechanical properties, inclusive of for example compressive modulus and/or strength and flexural modulus/strength of the feedstock and then in turn the resultant construction product. Pyrolysis of the feedstock also provides a source of bio-oil and/or bio-gas for further downstream processing.

Pyrolysis of the feedstock preferably produces pyrolyzed feedstock particles with a narrower particle size distribution compared to non-pyrolyzed feedstock. Pyrolyzed feedstock particles have improved size regularity which results in a construction product with improved surface finish due to a more regular particle size distribution. The improved surface finish translates to an improved edge definition leading to more efficient installation of the resultant construction product.

Pyrolysis of the bio-aggregate preferably produces pyrolyzed feedstock particles with a reduced water content (preferably a uniform water content) compared to non-pyrolyzed feedstock particles.

Pyrolyzed feedstock has an improved ability to sequester volatile organic components (VOCs) out of the atmosphere due to the ionic nature of the particle surface and the increased surface area compared to non-pyrolyzed feedstock particles.

The construction product comprises inert, non-biodegradable pyrolyzed feedstock which may have indefinitely sequestered biogenic carbon within the pyrolyzed feedstock.

The ratio of the amount of pyrolyzed feedstock (wt. %) to the amount of binder (wt. %) within the mixture is preferably at least 1:10, preferably at least 1:8, for example at least 1:6. The ratio of the amount of pyrolyzed feedstock (wt. %) to the amount of binder (wt. %) within the mixture is preferably no more than 1:1.5, preferably no more than 1:2, for example no more than 1:3. The ratio of the amount of pyrolyzed feedstock (wt. %) to the amount of binder (wt. %) within the mixture is preferably between 1:10 to 1:1.5, preferably between 1:8 and 1:2, preferably between 1:6 and 1:3.

The pyrolyzed feedstock comprises pyrolyzed bio-aggregate. The bio-aggregate may be selected from any of the examples of bio-aggregate described herein. The pyrolyzed feedstock may be obtained from pyrolysis of post-consumer and/or post-industrial waste. In some examples, the pyrolyzed feedstock is made up entirely of pyrolyzed bio-aggregate. References to pyrolyzed feedstock herein can therefore optionally be substituted with reference to pyrolyzed bio-aggregate. In some examples, the pyrolyzed feedstock is made up entirely of pyrolyzed post-consumer and/or post-industrial waste. In some examples, the pyrolyzed feedstock comprises both i) pyrolyzed bio-aggregate and ii) pyrolyzed post-consumer and/or post-industrial waste.

The construction product has been found to have improved in use performance benefits when using pyrolyzed feedstock due to the change in structure of the bio-aggregate present within the product. Examples of improved performance benefits of the construction product include one or more of: fire retardancy; and/or insulation/thermal conductivity; and/or removal of VOCs; and/or moisture buffering capacity, and any combination thereof.

The maximum particle size of the granulates of the pyrolyzed feedstock is preferably no greater than 100 mm, more preferably no greater than about 70 mm, more preferably no greater than about 50 mm, more preferably no greater than 40 mm, for example no greater than 30 mm.

The maximum particle size of the granulates of the pyrolyzed feedstock is at least about 0.1 mm, more preferably at least about 0.15 mm, more preferably at least about 0.2 mm, for example at least about 0.25 mm.

The range of maximum particle sizes of the granulates of the pyrolyzed feedstock is preferably within the range of between 0.1 mm and 100 mm, preferably in the range of between 0.1 mm and 70 mm, preferably in the range of between 0.1 mm and 50 mm.

The profile of the distribution of maximum particle sizes of the granulates of the pyrolyzed feedstock is of importance to both the manufacturing and structural performance of the resultant product.

As described above, particle size distribution is conventionally defined by the method by which it is determined. One suitable method is sieve analysis, where powder is separated on sieves of different sizes. The particle size distribution is therefore determined in terms of discrete size ranges based on the sizes of sieves used. The particle size distribution may be presented in cumulative form. The maximum particle sizes and particle size distributions described herein may be determined by sieve analysis.

In some embodiments, the pyrolyzed feedstock comprises a predetermined particle size distribution ranging from a minimum value of a maximum particle size to a maximum value of a maximum particle size.

In some embodiments, the cumulative particle size distribution function of the pyrolyzed feedstock, when determined from the highest value of maximum particle size to the lowest value of maximum particle size, is substantially S-shaped.

In some embodiments, the pyrolyzed feedstock may be fine, and may have a maximum particle size of substantially 5 mm. The pyrolyzed feedstock may have a relatively narrow particle size distribution, and over 50% of the pyrolyzed feedstock has a particle size of 1-4 mm, and over 30% may have a particle size of less than 1 mm. Over 50% of the pyrolyzed feedstock may have a maximum particle size of between 1 mm and 4 mm. Over 30% of the pyrolyzed feedstock may have a maximum particle size of less than 1 mm.

In some embodiments, at least the majority of the particles may have a maximum particle size of less than one third of the construction product thickness, for example where the construction product is manufactured as a planar sheet, such as an internal lining board/plasterboard (as measured between opposing surfaces of the mixture optionally lined with planar lining material). In some embodiments, substantially none of the particles may have a maximum particle size of greater than one third of the construction product thickness, for example where the construction product is manufactured as a planar sheet, such as an internal lining board/plasterboard (as measured between opposing surfaces of the mixture optionally lined with planar lining material).

In some embodiments, the pyrolyzed feedstock comprises a first pyrolyzed feedstock portion having a fine particle size (for example having a maximum particle size of no more than 5 mm) to provide for increased reactivity to form the crystalline calcium silica hydrate. The pyrolyzed feedstock preferably further comprises a second pyrolyzed feedstock portion having a larger particle size than the first pyrolyzed feedstock portion (for example, the second pyrolyzed feedstock portion comprises granulates having a maximum particle size of no more than 100 mm) to provide a product with reduced density and improved thermal and/or hygroscopic properties. The first and second pyrolyzed feedstock portions may be provided by the same feedstock or by different feedstock.

The pyrolyzed bio-aggregate may comprise a mixture of fine particle sizes and larger particle sizes. The presence of fine particle size pyrolyzed bio-aggregate particles increase the reactivity to improve the yield of calcium silica hydrate. The presence of larger particle size pyrolyzed bio-aggregate particles provides for a construction product with reduced density and/or improved thermal and/or hygroscopic properties.

The mixture may further comprise one or more additives selected from: viscosity modifying agents; and/or coupling agents; and/or water retention agents; or any combination thereof. The one or more additives may comprise one or more carbohydrates, for example polysaccharides, such as for example methylated cellulose ether. The one or more additives are preferably plant-derived. The mixture may further comprise an air entraining agent such as lignin sulfonate.

The mixture may further comprise a plasticizer. The plasticizer may be present in the mixture in an amount of up to 2 wt. % of the weight of the binder. Preferably the plasticizer is present in the mixture in an amount between 0.5 wt. % and 1.5 wt. % of the weight of the binder.

In some embodiments, the pyrolyzed feedstock has a silica content of at least 2 wt. %, preferably at least 4 wt. %. The silica present within the pyrolyzed feedstock forms alkaline earth metal silica hydrate (for example calcium silica hydrate) providing a pozzolanic effect which has been found to improve the strength of the resultant product. The present invention therefore reduces the reliance of the product on the presence of additional high carbon intensity binders (such as cement) and can remove the requirement for other mineral based pozzolans such as metakaolin and silica fume.

The construction product may be an internal board, such as an internal lining board, an insulation board, or an acoustic panel. The construction product may, for example, be an internal lining board, a tile, an insulation board, an acoustic panel, a block or a lintel. The construction product may, for example, be a moulded construction product (e.g., a lining board, an insulation board, an acoustic panel, a tile, a block or a lintel formed at least on part by moulding). The moulded construction product may be formed using extrusion moulding, for instance by extruding through a die. The die could for instance be one or more rollers through which the mixture is continuously extruded. The construction product may be formed by continuously extruding the mixture on a conveyor, wherein the mixture is provided on the conveyor, and the die is defined by a gap between the conveyor and a roller. In some examples the planar lining material is applied to an outer face of the mixture by the roller during continuous extrusion. The die may also include a static (i.e. non-rolling) element in conjunction with the roller. In other examples, the construction product might be cast or 3D-printed. If, for example, the construction product is an internal lining board (or an insulation board or an acoustic panel), the construction product may comprise an accelerated carbonation-cured mixture of the binder and bio-aggregate provided on planar lining material, preferably between two opposed sheets of planar lining material. The planar lining material is preferably provided on one or both outer faces of the mixture, for example moulded mixture.

In some embodiments the planar lining material is paper. In some examples, the paper has a weight of up to 250 gsm. The paper may have a weight of at least 150 gsm. The paper may have a weight of between 170 gsm and 200 gsm and may be a recycled paper. In a further embodiment the lining material is hessian.

The mixture may include a cellulose adhesive, which may be methyl cellulose. A cellulose adhesive may be used to adhere the lining material to the remainder of the materials. The cellulose adhesive may contain up to 2 wt. % cellulose in water. The cellulose adhesive may contain between 1 and 2% cellulose in water. The cellulose may be methyl cellulose.

The density of the construction product may be at least 400 kg/m³. Preferably the density of the construction product is at least at least 500 kg/m³, such as 650 kg/m³. The density of the construction product may be up to 1000 kg/m³. Preferably the density of the construction product is up to 700 kg/m³, such as 650 kg/m³. The density of the construction product may be between 500 kg/m³ and 750 kg/m³, such as 650 kg/m³.

The construction product thickness, if manufactured in a planar sheet (as measured between opposing surfaces of the mixture optionally lined with planar lining material), may be at least 5 mm, preferably at least 9 mm, for example about 10 mm. The construction product thickness may be no more than 250 mm. The construction product thickness may be no more than 50 mm. Preferably, the construction product thickness is between 5 mm and 50 mm, preferably between 9 mm and 50 mm, for example between 10 mm and 50 mm. Most preferably, the construction product thickness is between 8 mm and 15 mm.

In some examples, the construction product is made from a combination of different board types. For instance, an internal face of the construction product may be an insulation board, and an external face of the construction product may be made from an internal lining board. The internal lining board may be thinner and denser than the insulation board.

In some alternative examples, the construction product may be a plaster or a render formed by the mixture described herein. The plaster may be an internal plaster that is for use on the internal walls of a building. The render may be an external render that is for use on the external walls of a building.

In such examples, the plaster or render is not cured during production (using accelerated carbonation curing or otherwise). Instead, the plaster/render is cured on-site after being applied to an internal wall or an external wall. The plaster or render may, for example, be a dry particulate mixture (e.g., a dry mortar product) to which water is added on site to enable or cause the plaster/render to cure.

According to a further aspect of the disclosure there is provided a method of manufacturing a construction product comprising an accelerated carbonation-cured mixture, comprising:
producing a mixture of a binder comprising at least one of: an alkaline earth metal oxide and/or alkaline earth metal hydroxide; and bio-aggregate; and
exposing the mixture to a carbon dioxide containing feed stream for accelerated carbonation of the mixture.

In some examples, the construction product is an internal board, and the method further comprises forming the mixture into a predetermined geometric shape; and providing a planar lining material on one or more outer faces of the predetermined geometric shape. The internal board may be an internal lining board.

The binder and/or the bio-aggregate may be as described above. The mixture may further comprise one or more additives as described above.

Exposure of the mixture to a carbon dioxide containing feed stream enables the mixture to absorb carbon dioxide from the feed stream. Furthermore, exposure to a carbon dioxide containing feed stream has been found to accelerate the cure rate (and thereby reducing the curing time) of the mixture to provide the resultant construction product with increased mechanical properties.

In some embodiments, the mixture is exposed to a carbon dioxide containing feed stream for a predetermined time period. In some examples, the predetermined time period for exposure is sufficient to ensure substantially full carbonation of the mixture (and resultant construction product) is achieved. In other examples, the predetermined time period for exposure may only be sufficient to partially carbonate the mixture (and resultant construction product).

The method preferably further comprises forming the mixture (for example moulding the mixture) into a predetermined geometric shape, such as for example a substantially planar shape.

The mixture may be supplied into a mould or formwork to form the predetermined geometric shape, such as for example a planar material, for example a board (such as an internal lining board, an insulation board or an acoustic panel). The mould may be an extrusion mould such as a die. The die could for instance be one or more rollers through which the mixture is continuously extruded. The construction product may be formed by continuously extruding the mixture on a conveyor, wherein the mixture is provided on the conveyor, and the die is defined by a gap between the conveyor and a roller. In some examples, the planar lining material is applied to an outer face of the mixture by the roller during continuous extrusion. The die may also include a static (i.e. non-rolling) element in conjunction with the roller.

In some embodiments the planar lining material is paper. In some examples, the paper has a weight of up to 250 gsm. The paper may have a weight of at least 150 gsm. The paper may have a weight of between 170 gsm and 200 gsm and may be a recycled paper. In a further embodiment the lining material is hessian.

The mixture may include a cellulose adhesive, which may be methyl cellulose. A cellulose adhesive may be used to adhere the lining material to the remainder of the materials. The cellulose adhesive may contain up to 2 wt. % cellulose in water. The cellulose adhesive may contain between 1 and 2% cellulose in water. The cellulose may be methyl cellulose.

The ratio of the amount of bio-aggregate (wt. %) to the amount of binder (wt. %) within the mixture is preferably at least 1:10, preferably at least 1:8, for example at least 1:6. The ratio of the amount of bio-aggregate (wt. %) to the amount of binder (wt. %) within the mixture is preferably no more than 1:1.5, preferably no more than 1:2, for example no more than 1:3. The ratio of the amount of bio-aggregate (wt. %) to the amount of binder (wt. %) within the mixture is preferably between 1:10 to 1:1.5, preferably between 1:8 and 1:2, preferably between 1:6 and 1:3.

Preferably, the carbon dioxide containing feed stream comprises an increased concentration of carbon dioxide compared to atmospheric concentrations. For example, the concentration of carbon dioxide within the carbon dioxide containing feed stream may be at least 0.1% by volume, may be at least 1% by volume, may be at least 5% by volume, preferably at least 10% by volume, for example at least 20% by volume. Preferably, the concentration of carbon dioxide within the carbon dioxide containing feed stream is between 20% and 90% by volume, preferably between 20% and 80% by volume, preferably between 20% and 70%, preferably between 20% and 60%.

The carbon dioxide containing feed stream preferably further comprises water vapour. The relative humidity of the carbon dioxide containing feed stream may be at least 50%, may be at least 65%, preferably at least 70 or 75%, and preferably no more than 85%.

The carbon dioxide containing feed stream may be provided at a temperature of at least 15° C. The carbon dioxide containing feed stream is preferably provided at a temperature elevated above room temperature. Preferably, the carbon dioxide containing feed stream is provided at a temperature of at least 25° C., preferably at least 30° C. Preferably, the carbon dioxide containing feed stream is provided at a temperature of no more than 90° C.

In some embodiments, the carbon dioxide containing feed stream is obtained from waste gases from one or more industrial processes. For example, the carbon dioxide containing feed stream may be obtained from one or more of the following sources: directly from flue gas; from firing of limestone in the production of calcium oxide; from firing of limestone clinker in the production of cement; from burning methane to create heat for industrial processes; from pyrolysis of bio-aggregate (i.e. directly from the pyrolysis of bio-aggregate or indirectly as a result of burning biogas and/or bio-oil obtained from the pyrolysis of bio-aggregate); from anaerobic digestion processes; from direct air capture or any combination thereof. The carbon dioxide containing feed stream may comprise low grade carbon dioxide emissions. The costs associated with increasing the carbon dioxide concentration within these low-grade emissions and/or to transport these emissions from their source to the required site for use is cost prohibitive. The method therefore utilises sources of low-grade carbon dioxide emissions to efficiently remove carbon from the atmosphere. If the carbon dioxide feed stream is obtained from a high-temperature source, the carbon dioxide feed stream may be cooled using a heat exchanger prior to introducing the carbon dioxide feed stream to the mixture. The heated fluid produced at the heat exchanger during cooling of the carbon dioxide feed stream may be used to heat the mixture during the curing and/or drying steps described herein.

The mixture may be at a temperature of at least 15° C. during exposure of the mixture to a carbon dioxide containing feed stream. The mixture may be at a temperature within the range of from 15° C. to 60° C. during exposure of the mixture to a carbon dioxide containing feed stream. The mixture may be heated to a predetermined temperature during exposure of the mixture to a carbon dioxide containing feed stream. Preferably, the mixture is heated to a temperature of at least 25° C. The mixture may be heated to a temperature within the range of from 25° C. to 60° C. Preferably the mixture is heated to a temperature of no more than 40° C. Preferably, the mixture is heated to a temperature within the range of from 25° C. to 40° C.

Heating of the mixture and/or heating of the carbon dioxide containing feed stream may be produced by the burning of biogas or bio-oil (for example biogas or bio-oil generated by pyrolysis of bio-aggregate). The method reduces the use of fossil fuel and provides a method of using the resultant product of pyrolysis, thereby efficiently sequestering biogenic carbon, whilst further utilising the heat generated by the pyrolysis process in the manufacturing process of the product.

The step of exposing the mixture to a carbon dioxide containing feed stream is preferably carried out at atmospheric pressure. In some embodiments, the step of exposing the mixture to a carbon dioxide containing feed stream is preferably carried out at a pressure of greater than 1 atmosphere. Preferably, the step of exposing the mixture to a carbon dioxide containing stream is carried out at a pressure of no more than 13 bar.

Increasing the pressure of carbon dioxide during the accelerated carbonation step has two effects. The first is to modify the density and therefore the compressive strength of the product has been found to increase. The second is the expedited and increased rate of uptake of carbon dioxide by the calcium carbonate, enabling the product to gain strength rapidly whilst rapidly removing carbon dioxide from the flue gas. As such, the use of an accelerated carbonation step has been found to produce a construction product with increased sheer and flexural strength. The resultant construction product may also provide for improved paper adhesion.

The use of elevated temperatures as a result of the exothermic reaction occurring during the curing stage (accelerated carbonation) also leads the construction product to achieve a predetermined strength over a shorter time period. The active control of the temperature, in relation to moisture content in the air and carbon dioxide levels enables efficient carbonation.

In some embodiments, during the accelerated carbonation stage, the concentration of carbon dioxide may be increased over time, for example increased steadily (at a predetermined rate) over time to control the exothermic carbonation process. This can be done dynamically with temperature and humidity.

The method may further comprise monitoring the humidity of the feed stream during the step of exposing the mixture to carbon dioxide containing feed stream.

In order to optimise the accelerated carbonation cure times and to ensure maximum strength development of the product, it is important to monitor humidity to ensure that the humidity remains within predetermined maximum and minimum levels. Preferably, the minimum humidity during the step of exposing the mixture to a carbon dioxide containing feed stream is at least 20%, preferably at least 30%, even more preferably at least 40%. Preferably, the maximum humidity during the step of exposing the mixture to a carbon dioxide containing feed stream is no more than 50%, preferably no more than 60%, preferably no more than 70%, even more preferably 90% relative humidity. Preferably, the humidity levels during the step of exposing the mixture to a carbon dioxide containing feed stream is between 20% and 70%.

In some embodiments, the method further comprises controlling the humidity, for example, during the step of exposing the mixture to carbon dioxide containing feed stream. The humidity may be controlled in response to determining that the humidity is less than the predetermined minimum level, or greater than the predetermined minimum level. The humidity in a chamber in which the mixture is being exposed to the carbon dioxide containing feed stream can be measured by a humidity sensor. A controller may cause water vapour to be released into the chamber or the feed stream, based on a signal from the humidity sensor. The signal may indicate a measurement of the relative humidity level in the chamber is below a predetermined threshold. Preferably, the predetermined threshold (i.e., minimum) humidity during the step of exposing the mixture to a carbon dioxide containing feed stream is 20% relative humidity, preferably 30% relative humidity, even more preferably 40% relative humidity. The water vapour may be from a mains water supply, recycled water from the system, such as condensed water recovered from the drying of the mixture, or water recovered from scrubbing of flue gas. A humidifier may be used to increase the humidity to at least the predetermined minimum level, and/or a dehumidifier may be used to decrease the humidity to the predetermined maximum level or lower. The controller may cause water vapour to be extracted from the chamber or the feed stream, based on a signal from the humidity sensor. The signal may indicate a measurement of the relative humidity level in the chamber is above a predetermined threshold. Preferably, the predetermined threshold (i.e., maximum) humidity during the step of exposing the mixture to a carbon dioxide containing feed stream is 50% relative humidity, preferably 60% relative humidity, preferably 70% relative humidity, even more preferably 90% relative humidity.

The controller may comprise at least one processor; and at least one memory including computer program code configured to, with the at least one processor, to cause the humidifier to emit water vapour and/or to cause the dehumidifier to extract water vapour. The controller is operationally coupled to humidity sensor(s), the humidifier and/or the dehumidifier. Any number or combination of intervening elements can exist (including no intervening elements) between the controller and these elements. The controller may, for example, be a chipset. The controller may comprise at least one processor/processing circuitry and at least one memory. The controller may be implemented in hardware alone, have certain aspects in software including firmware alone or can be a combination of hardware and software (including firmware). The computer program code may be comprised in a computer program, a non-transitory computer readable medium, a computer program product, a machine readable medium. In some but not necessarily all examples, the computer program instructions may be distributed over more than one computer program.

It is to be understood that the humidity levels required are dependent on the concentration of carbon dioxide within the carbon dioxide containing feed stream and the temperature of the feed stream.

The step of exposing the mixture to a carbon dioxide feed stream may be carried out within a chamber. The chamber may be an oven, for example a crossflow oven. The chamber may have an inlet in direct supply with the source of the carbon dioxide feed stream. The chamber may include a fan configured to provide random movement of air around the chamber. The fan may be a rotating plenum fan.

During the step of exposing the mixture to the carbon dioxide containing feed stream, the mixture may be regularly agitated or moved to encourage evaporation of water which may condensate on the mixture.

The step of producing the mixture may occur prior to the step of exposing the mixture to a carbon dioxide containing feed stream.

In some embodiments, the production of the mixture, optionally forming a predetermined geometric shape, may occur simultaneously to the step of exposing the mixture to a carbon dioxide containing feed stream. The production of the mixture may comprise: i) combining the bio-aggregate and binder to form the mixture, ii) adding water to the mixture such that the mixture is in the form of a paste, and iii) mixing the paste. The mixture may be exposed to the carbon dioxide containing feed stream during any one of these steps, any combination of two of these steps, or all three of these steps. The production of the mixture may be carried out at a pressure of between 0.5 bar and 1.5 bar, for example at substantially atmospheric pressure (1 bar). The production of the mixture may be carried out at a temperature of between 15° C. and 70° C., for example at substantially room temperature (25° C.).

When the mixture is exposed to a carbon dioxide containing feed stream during the mixing stage as described in the paragraph above, the binder can react with the carbon dioxide, thereby enabling carbon dioxide to be captured at an early stage of forming the construction product. The introduction of carbon dioxide at the production/mixing stage can also reduce the curation time for the mixture. When the mixture is exposed to a carbon dioxide containing feed stream during the production/mixing stage in water, carbonic acid may be present in the mixture. The carbonic acid may react with the binder to form carbonates, which can affect the final strength of the construction product. The strength of the final product can therefore be tuned by adjusting the amount of carbon dioxide introduced to the mixture.

Furthermore, in examples where pyrolyzed bio-aggregate is present in the mixture, the carbon dioxide can adsorb to the pyrolyzed bio-aggregate by physisorption or chemisorption. Where an alkaline hydroxide is included in the mixture, the alkaline hydroxide can activate the pyrolyzed bio-aggregate to adsorb more carbon dioxide.

The step of forming (for example moulding) the mixture into a predetermined geometric shape may be conducted prior to and/or during exposure of the mixture to the carbon dioxide containing feed stream. The step of forming the mixture into a predetermined geometric shape may be conducted prior to exposure of the mixture to the carbon dioxide containing feed stream. The mixture may be formed into a predetermined geometric shape using extrusion moulding, preferably continuous extrusion moulding, for example by continuously extruding through a die. The die could for instance be one or more rollers through which the mixture is continuously extruded. The construction product may be formed by continuously extruding the mixture on a conveyor, wherein the mixture is provided on the conveyor, and the die is defined by a gap between the conveyor and a roller. In some examples, the planar lining material is applied to an outer face of the mixture by the roller during continuous extrusion. The die may also include a static (i.e. non-rolling) element in conjunction with the roller. The mixture may be introduced in between two sheets of planar lining material on a conveyor between rollers to gauge the thickness of the predetermined geometric shape.

In some examples, the mixture may be exposed to a first carbon dioxide containing feed stream prior to forming the mixture into a predetermined geometric shape, and exposed to a second carbon dioxide containing feed stream after forming the mixture into a predetermined geometric shape. In such examples, any carbon dioxide not utilised in the first carbon dioxide containing feed stream (i.e. excess carbon dioxide not incorporated into the mixture during exposure to the first carbon dioxide containing feed stream) may be recycled and used in the second carbon dioxide containing feed stream.

Following exposure to the carbon dioxide containing feed stream(s) (which could be a single carbon dioxide containing feed stream or multiple carbon dioxide feed streams as described in the paragraph above), the mixture may include between 0.1 wt. % and 15 wt. % of absorbed carbon dioxide. Following exposure to the carbon dioxide containing feed stream, the mixture may include between 1 wt. % and 15 wt. % of absorbed carbon dioxide.

The method preferably further comprises providing a planar lining material on one or more outer faces of the predetermined geometric shape, for example of the planar shaped mixture (such as for example a board). The planar lining material may be provided on each outer face of a pair of opposed outer faces of the planar shaped mixture. In some embodiments, the planar lining material may also extend beyond, and for example around at least a portion of, one or more edges of the outer face(s) of the planar shaped board. The planar lining material may help to form the edge(s) of one or more outer face(s) of the planar shaped board and to provide shape thereto. The planar shaped board provides a high surface area enabling effective carbon dioxide uptake during accelerated carbonation.

In some examples, the planar lining material is applied to an outer face of the mixture by a roller during continuous extrusion. In some embodiments, the mixture may be introduced, for example pumped, in-between two sheets of planar lining material on a conveyor between rollers to gauge the thickness of the resultant moulded mixture.

In some embodiments, the mixture may be applied onto a sheet of planar lining material, and then a further piece of lining material placed on an opposed surface of the mixture. The combination of the mixture together with the planar lining material may be subsequently pressed into the desired shaped having predetermined dimensions.

The bio-aggregate and binder may be mixed together with water. When water has been added to the mixture, the mixture may be in the form of a paste. The ratio of binder to water may be between 1:1 and 1:2.5. The binder may form 15 wt. % to 55 wt. % of the paste. Preferably, the binder forms 25 wt. % to 50 wt. % of the paste, such as 35 wt. % to 45 wt. % of the paste. The bio-aggregate may form 5 wt. % to 50 wt. % of the paste. Preferably, the bio-aggregate forms 7 wt. % to 20 wt. % of the paste, such as 10 wt. % of the paste. The water may form 20 wt. % to 70 wt. % of the paste. Preferably, the water forms 30 wt. % to 60 wt. % of the paste, such as 40 to 50 wt. % of the paste. The paste may be subsequently dried. For example, the paste may be dried at a temperature of between 30-100° C.

An adhering material may be provided on the planar lining material to adhere it to the mixture of binder and bio-aggregate. The adhering material may be a cellulose solution, and may be methyl cellulose solution.

The method is preferably carried out by extrusion, preferably continuous extrusion.

The method has been found to produce a construction product. The method has been found to result in a decreased cure time for formation of the construction product, leading to a greater throughput for the manufacturing facility with reduced associated costs. The method enables the product to develop the desired strength properties over a shorter time period compared to conventional methods for producing bio-aggregate based construction products.

The construction product formed from the method might be different from an internal lining board/plasterboard in some examples. For instance, it might be a tile, insulation board, an acoustic panel, a block or a lintel.

The combination of accelerated carbonation and pyrolyzed feedstock allows a greater amount of carbon dioxide to be present in the core of the construction product.

The method enables a large amount of carbon to be captured early in the production stages of the construction product. The method provides a method for efficiently sequestering carbon dioxide containing emissions from waste sources, such as for example flue gas emissions, thereby reducing any economic implications resulting from carbon dioxide generation. Furthermore, such waste streams typically contain waste heat and water vapour which can also be harnessed within the method to efficiently produce a construction product with predetermined strength properties. The method enables production, for example continuous production, of a construction product that is considered to be low-carbon or carbon-negative.

According to a further aspect of the disclosure, there is provided a method of manufacturing a mixture for a construction product, the method comprising:
obtaining feedstock;
pyrolyzing the feedstock to obtain a pyrolyzed feedstock; and
mixing a binder comprising at least one of: an alkaline earth metal oxide and/or alkaline earth metal hydroxide with the pyrolyzed feedstock to form the mixture for the construction product.

In some examples, the method is a method of manufacturing the construction product, the feedstock is a bio-aggregate, the construction product is an internal board, and the method further comprises forming the mixture into a predetermined geometric shape; and providing a planar lining material on one or more outer faces of the predetermined geometric shape. The internal board may be an internal lining board.

The feedstock may for example be bio-aggregate. The binder and/or the bio-aggregate may be as described above. The pyrolyzed feedstock may be as described above. The mixture may further comprise one or more additives as described above.

Pyrolyzing the feedstock may include heating the feedstock (for example bio-aggregate) to an elevated temperature of 500° C. or above, in the absence of oxygen. The pyrolysis may comprise heating the feedstock to between 500° C. and 1000° C. The pyrolysis may comprise heating the feedstock to between 500° C. and 800° C. The pyrolysis may comprise heating the feedstock to between 500° C. and 700° C. The feedstock may be heated from substantially room temperature to between 500° C. and 1000° C. in a time period of 5 minutes to 1 hour. The feedstock may be heated from substantially room temperature to between 500° C. and 1000° C. in a time period of 15 minutes to 1 hour. The feedstock may be heated from substantially room temperature to between 500° C. and 800° C. in a time period of 5 minutes to 1 hour. The feedstock may be heated from substantially room temperature to between 500° C. and 800° C. in a time period of 15 minutes to 1 hour. The feedstock may be heated at a temperature ramp rate of between 10° C. per minute and 125° C. per minute, such as 30° C. per minute.

Pyrolysis of bio-aggregate produces biogas and/or bio-oil, heat and pyrolyzed bio-aggregate.

Pyrolysis of the feedstock preferably homogenises the feedstock.

The ratio of the amount of pyrolyzed feedstock (wt. %) to the amount of binder (wt. %) within the mixture is preferably at least 1:10, preferably at least 1:8, for example at least 1:6. The ratio of the amount of pyrolyzed feedstock (wt. %) to the amount of binder (wt. %) within the mixture is preferably no more than 1:1.5, preferably no more than 1:2, for example no more than 1:3. The ratio of the amount of pyrolyzed feedstock (wt. %) to the amount of binder (wt. %) within the mixture is preferably between 1:10 to 1:1.5, preferably between 1:8 and 1:2, preferably between 1:6 and 1:3.

The construction product may be an internal board, such as an internal lining board, an insulation board, or an acoustic panel. The construction product might be an internal lining board, an insulation board, an acoustic panel, a tile, a block or a lintel. In such examples, the method may preferably further comprise forming the mixture (for example moulding the mixture) into a predetermined geometric shape, such as for example a substantially planar shape. Water may be added to the mixture prior to forming the mixture into a predetermined shape.

The mixture may be supplied into a mould, die or formwork to form the predetermined geometric shape. The predetermined geometric shape may be formed using extrusion moulding. The moulded construction product may be formed using continuous extrusion moulding. For example, the mixture may be continuously extruded through a die to form the predetermined geometric shape. The die could for instance be one or more rollers through which the mixture is continuously extruded. The construction product may be formed by continuously extruding the mixture on a conveyor, wherein the mixture is provided on the conveyor, and the die is defined by a gap between the conveyor and a roller. In some examples, the planar lining material is applied to an outer face of the mixture by the roller during continuous extrusion. The die may also include a static (i.e. non-rolling) element in conjunction with the roller. The mixture may be introduced in between two sheets of planar lining material on a conveyor between rollers to gauge the thickness of the predetermined geometric shape.

The mixture may be at a temperature of at least 15° C. during exposure of the mixture to a carbon dioxide containing feed stream. The mixture may be at a temperature within the range of from 15° C. to 60° C. during exposure of the mixture to a carbon dioxide containing feed stream. The mixture may be heated to a predetermined temperature to cure the mixture and form the construction product. Preferably, the mixture is heated to a temperature of at least 25° C. The mixture may be heated to a temperature within the range of from 25° C. to 60° C. Preferably the mixture is heated to a temperature of no more than 40° C. Preferably, the mixture is heated to a temperature within the range of from 25° C. to 40° C.

Heating of the mixture (for example, while the mixture is curing into the predetermined shape) may be achieved by burning biogas or bio-oil (for example biogas or bio-oil generated from the pyrolysis of bio-aggregate). The method of the present invention reduces the use of fossil fuel and provides a method of using the resultant product of pyrolysis and thereby efficiently sequestering biogenic carbon, whilst further utilising the heat generated by the pyrolysis process in the manufacturing process of the product.

The mixture may be cured for any suitable time period or residency time.

It has been found that when the method is carried out at lower temperatures and over shorter residency time periods, less VOCs are emitted and a larger yield of pyrolyzed bio-aggregate is produced with a reduced yield of bio-oil and bio gas.

The method may comprise subjecting the mixture to increased pressure, for example at greater than 1 atmosphere, preferably no more than 13 bar.

By increasing the pressure, the density and compressive strength of the product may increase. This may lead to a construction product with increased sheer and flexural strength. The construction product may also provide for improved paper adhesion.

The method preferably further comprises providing a planar lining material on one or more outer faces of the predetermined geometric shape, for example of the planar shaped mixture (such as for example a board). The planar lining material may be provided on each outer face of a pair of opposed outer faces of the planar shaped mixture. In some embodiments, the planar lining material may also extend beyond, and for example around at least a portion of, one or more edges of the outer face(s) of the planar shaped board. The planar lining material may help to form the edge(s) of one or more outer face(s) of the planar shaped board and to provide shape thereto.

In some examples, the planar lining material is applied to an outer face of the mixture by a roller during continuous extrusion. In some embodiments, the mixture may be introduced, for example pumped, in between two sheets of planar lining material on a conveyor between rollers to gauge the thickness of the resultant moulded mixture.

In some embodiments, the mixture may be applied onto a sheet of planar lining material, and then a further piece of lining material placed on an opposed surface of the mixture. The combination of the mixture together with the planar lining material may be subsequently pressed into the desired shaped having predetermined dimensions.

In some embodiments the planar lining material is paper. In some examples, the paper has a weight of up to 250 gsm. The paper may have a weight of at least 150 gsm. The paper may have a weight of between 170 gsm and 200 gsm and may be a recycled paper. In a further embodiment the lining material is hessian.

The mixture may include a cellulose adhesive, which may be methyl cellulose. A cellulose adhesive may be used to adhere the lining material to the remainder of the materials. The cellulose adhesive may contain up to 2 wt. % cellulose in water. The cellulose adhesive may contain between 1 and 2% cellulose in water. The cellulose may be methyl cellulose.

The pyrolyzed feedstock (for example pyrolyzed bio-aggregate) and binder may be mixed together with water such that the mixture is in the form of a paste. The binder may form 15 wt. % to 55 wt. % of the paste. Preferably, the binder forms 25 wt. % to 50 wt. % of the paste, such as 35 wt. % to 45 wt. % of the paste. The pyrolyzed feedstock may form 5 wt. % to 50 wt. % of the paste. Preferably, the pyrolyzed feedstock forms 8 wt. % to 30 wt. % of the paste, such as 12 wt. % to 18 wt. % of the paste. The water may form 20 wt. % to 70 wt. % of the paste. Preferably, the water forms 30 wt. % to 60 wt. % of the paste, such as 40 to 50 wt. % of the paste. The ratio of binder to water may be between 1:1 and 1:2.5. The mixture may be subsequently dried. For example, the mixture may be dried at a temperature of 30-100° C.

Use of pyrolyzed bio-aggregate has been found to enable a larger feedstock to water ratio in the paste, when compared to the use of unpyrolyzed bio-aggregate. The ratio of pyrolyzed bio-aggregate (wt. %) to water (wt. %) in the paste may is between 1:2 and 1:4. Preferably the ratio of pyrolyzed bio-aggregate (wt. %) to water (wt. %) in the paste is between 1:2.5 and 1:3.5.

An adhering material may be provided on the planar lining material to adhere it to the mixture of binder and pyrolyzed feedstock. The adhering material may be a cellulose solution, and may be methyl cellulose solution.

### The Method May Be Carried out by Extrusion, Preferably Continuous Extrusion.

In some examples, the construction product may be a plaster or a render formed by the mixture described herein. The plaster may be an internal plaster that is for use on the internal walls of a building. The render may be an external render that is for use on the external walls of a building. In such examples, the plaster or render is not cured during production (using accelerated carbonation curing or otherwise). Instead, the plaster/render is cured on-site after being applied to an internal wall or an external wall. The plaster or render may, for example, be a dry particulate mixture (e.g., a dry mortar product) to which water is added on site to enable or cause the plaster/render to cure.

The presence of pyrolyzed feedstock within the mixture has been found to decrease the viscosity of an extruded (preferably continuously extruded) paste. As a result, the rate of manufacture of the construction product has been significantly reduced whilst also reducing the amount of water required to manufacture the product. The reduced amounts of water present within the mixture lead to a reduced cure time for the product. This results in improved strength development of the product over a shorter time period.

The presence of pyrolyzed feedstock within the product has been found to provide good thermal and hygroscopic properties during the life of the product.

According to a further aspect of the disclosure, there is provided a method of manufacturing a construction product, wherein the construction product is an internal board and the method comprises: obtaining bio-aggregate; pyrolyzing the bio-aggregate to obtain a pyrolyzed bio-aggregate; mixing a binder comprising at least one of: an alkaline earth metal oxide and/or alkaline earth metal hydroxide with the pyrolyzed bio-aggregate to form a mixture for the construction product; forming the mixture into a predetermined geometric shape; and providing a planar lining material on one or more outer faces of the predetermined geometric shape. The internal board may be an internal lining board.

According to a further aspect of the disclosure, there is provided a construction product comprising a mixture, wherein the construction product is an internal board and the mixture comprises: pyrolyzed bio-aggregate; and a binder comprising at least one of: an alkaline earth metal oxide and/or alkaline earth metal hydroxide, wherein planar lining material is provided on one or both outer faces of the mixture. The internal board may be an internal lining board.

According to a further aspect of the disclosure, there is provided a method of manufacturing a construction product, wherein the construction product is an internal board comprising an accelerated carbonation-cured mixture, the method comprising: producing a mixture of bio-aggregate and a binder, the binder comprising an alkaline earth metal oxide or alkaline earth metal hydroxide; exposing the mixture to a carbon dioxide containing feed stream for accelerated carbonation of the mixture; forming the mixture into a predetermined geometric shape; and providing a planar lining material on one or more outer faces of the predetermined geometric shape. The internal board may be an internal lining board.

According to a further aspect of the disclosure, there is provided a construction product, wherein the construction product is an internal board and comprises an accelerated carbonation-cured mixture of: i) a binder comprising at least one of: an alkaline earth metal oxide and/or alkaline earth metal hydroxide; and ii) bio-aggregate, wherein planar lining material is provided on one or both outer faces of the mixture. The internal board may be an internal lining board.

### BRIEF DESCRIPTION OF THE DRAWINGS

For a better understanding of various examples of embodiments of the present invention reference will now be made by way of example only to the accompanying drawings in which:

FIG. 1 is a flow diagram of the method of producing a product prepared using accelerated carbonation according to some examples described in this specification; and

FIG. 2 is a flow diagram of the method of producing a product comprising pyrolyzed bio-aggregate according to an embodiment of the present disclosure.

### DETAILED DESCRIPTION

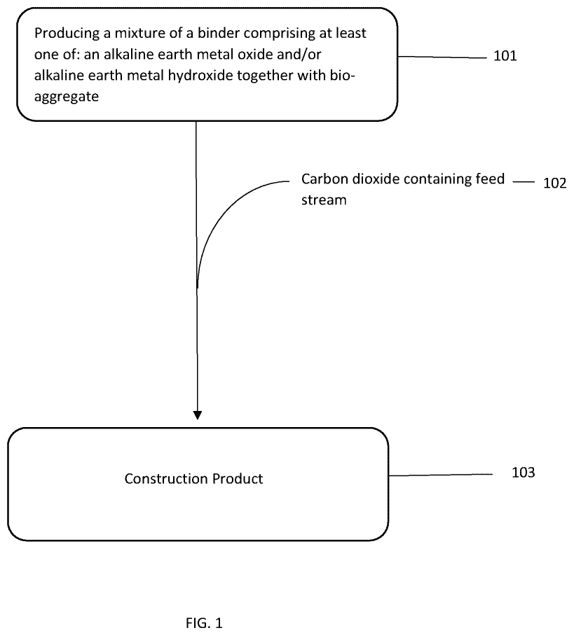

With reference to FIG. 1, a mixture 101 of a binder comprising at least one of: an alkaline earth metal oxide and/or alkaline earth metal hydroxide and bio-aggregate is prepared.

The bio-aggregate is selected from an agricultural product or by-product, for example a farm crop, farm crop by-product, food crop or food crop by-product. The bio-aggregate is preferably selected from one or more of: maize; wheat (for example common wheat (Triticum aestivum); rice; barley; millet; grasses (for example horsetail); rice husk; straw; squash; pumpkin; watermelon; cucumber; melon; hops; cannabis; celtis tress; nettles; wildflowers; rape straw; algae; seaweed; bamboo; rapeseed (Brassica napus); barley (Hordeum vulgare); oats (Avena sativa); flax; rice straw; corn straw; giant miscanthus (Miscanthus giganteus); sugarcane bagasse; sisal straw; hemp; or any combination thereof. It is however to be understood that other agricultural products or by-products may be used. For instance, the bio-aggregate may comprise organic by-products of food and drink processing. The organic by-products of food processing may for instance be selected from nutshells, fruit stones, coffee grounds, spent hops, spent grain, or pomace.

In some embodiments, the bio-aggregate is pyrolyzed bio-aggregate. The method may further comprise pyrolyzing bio-aggregate by heating the bio-aggregate, to elevated temperatures of at least 250° C., in the absence of oxygen. In some examples, the temperature to which the bio-aggregate is heated might be at least 350° C., at least 400° C. or at least 500° C. The pyrolysis may comprise heating the bio-aggregate to between 500° C. and 1000° C. The pyrolysis may comprise heating the bio-aggregate to between 500° C. and 800° C. The pyrolysis may comprise heating the bio-aggregate to between 500° C. and 700° C. The bio-aggregate may be heated from substantially room temperature to between 500° C. and 1000° C. in a time period of 5 minutes to 1 hour. The bio-aggregate may be heated from substantially room temperature to between 500° C. and 1000° C. in a time period of 15 minutes to 1 hour. The bio-aggregate may be heated from substantially room temperature to between 500° C. and 800° C. in a time period of 5 minutes to 1 hour. The bio-aggregate may be heated from substantially room temperature to between 500° C. and 800° C. in a time period of 15 minutes to 1 hour. During pyrolysis the bio-aggregate may be heated at a temperature ramp rate of between 10° C. per minute and 125° C. per minute, such as 30° C. per minute.

The bio-aggregate may be held in the pyrolysis process until the char is clean, with all of the bio-oil being driven off the bio-aggregate/char.

Water may be added to the mixture such that the mixture is in the form of a paste. The paste may be formed in a mixer. The mixer may be at a pressure of between 0.5 bar and 1.5 bar, such as substantially atmospheric pressure (1 bar). The mixer may be at a temperature between 15° C. and 70° C., such as substantially room temperature (25° C.). The mixture may be exposed to the carbon dioxide containing feed stream prior to and/or during the addition of water to the mixture. The binder may form 15 wt. % to 55 wt. % of the paste. Preferably, the binder forms 25 wt. % to 50 wt. % of the paste, such as 35 wt. % to 45 wt. % of the paste. The bio-aggregate may form 5 wt. % to 50 wt. % of the paste. Preferably, the bio-aggregate forms 7 wt. % to 20 wt. % of the paste, such as 10 wt. % of the paste. In examples where the bio-aggregate is pyrolyzed, the pyrolyzed bio-aggregate may form 8 wt. % to 30 wt. % of the paste, such as 12 to 18 wt. % of the paste. The water may form 20 wt. % to 70 wt. % of the paste. Preferably, the water forms 30 wt. % to 60 wt. % of the paste, such as 40 to 50 wt. % of the paste.

The mixture in the form of a paste may further comprise one or more additives selected from: viscosity modifying agents; and/or coupling agents; and/or water retention agents; and/or air entraining agents; and/or accelerators; and/or retarders; and/or cellulose adhesives; and/or plasticizers; or any combination thereof. The one or more additives may comprise one or more carbohydrates, for example polysaccharides, such as for example methylated cellulose ether. The one or more additives are preferably plant-derived.

The paste may be mixed in the mixer for a predetermined time period.

The mixture may be formed into a predetermined geometric shape, for example by use of a mould or formwork. The mixture may be formed into a predetermined geometric shape using extrusion moulding, which could be continuous extrusion mounding, for instance by extruding the mixture (in the form of the paste) through a die. The predetermined geometric shape may be a substantially planar shape. The die could for instance be one or more rollers through which the mixture is continuously extruded. The construction product may be formed by continuously extruding the mixture on a conveyor, wherein the mixture is provided on the conveyor, and the die is defined by a gap between the conveyor and a roller. In some examples a planar lining material is applied to an outer face of the mixture by the roller during continuous extrusion. The die may also include a static (i.e. non-rolling) element in conjunction with the roller. A planar lining material is preferably provided on one or both outer faces of the mixture. In some embodiments, the mixture may be introduced, for example pumped, in between two sheets of planar lining material on a conveyor between rollers to gauge the thickness of the resultant moulded mixture.

The mixture is exposed to a carbon dioxide feed stream 102 comprising at least 0.1% carbon dioxide by volume for a predetermined time period to provide the resultant construction product 103. The step of exposing the mixture to a carbon dioxide feed stream may be carried out within a chamber. The chamber could be the mixer in which the paste is formed or an oven, for example a crossflow oven.

The carbon dioxide feed stream 102 is obtained from waste gases from one or more industrial processes such as for example: directly from flue gas; from firing of limestone in the production of calcium oxide; from firing of limestone clinker in the production of cement; from burning methane to create heat for industrial processes; from pyrolysis of bio-aggregate; from anaerobic digestion processes; from direct air capture or any combination thereof.

The predetermined time period is sufficient to ensure substantially full carbonation of the mixture is achieved. It is to be appreciated that this predetermined time period will depend on a number of factors including for example the type and concentration of bio-aggregate present, the type and concentration of binder present, the flow rate and carbon dioxide concentration of the carbon dioxide containing feed stream, the temperature of the mixture, and the temperature of the feed stream.

In some examples, exposure to the carbon dioxide containing feed stream occurs during the production of the mixture. For instance, the mixture may be exposed to the carbon dioxide containing feed stream during the addition of water to the mixture in the mixer, and/or in the mixer after the water has been added (i.e., whilst the paste is being mixed).

Additionally or alternatively, the exposure to the carbon dioxide containing feed stream may occur during and/or after formation of the shape. For instance, the mixture may be exposed to the carbon dioxide containing feed stream after the mixture has been formed into the predetermined shape and after the lining material has been provided on one or both outer faces of the mixture. The mixture in the predetermined shape may then be exposed to the carbon dioxide feed stream in an oven, for example a crossflow oven. The oven may include a fan configured to provide random movement of air around the chamber. The fan may be a rotating plenum fan.

In examples where the mixture is exposed to a first carbon dioxide containing feed stream prior to forming the mixture into a predetermined geometric shape, and exposed to a second carbon dioxide containing feed stream after forming the mixture into a predetermined geometric shape, any carbon dioxide not utilised in the first carbon dioxide containing feed stream (i.e. excess carbon dioxide not incorporated into the mixture during exposure to the first carbon dioxide containing feed stream) may be recycled and used in the second carbon dioxide containing feed stream.

The mixture and/or carbon dioxide containing feed stream may be heated to a predetermined temperature.

Heating of the mixture and/or heating of the carbon dioxide containing feed stream may be produced by the burning of biogas or bio-oil obtained from the pyrolysis of bio-aggregate. The method reduces the use of fossil fuel and provides a method of using the resultant product of pyrolysis, thereby efficiently sequestering biogenic carbon, whilst further utilising the heat generated by the pyrolysis process in the manufacturing process of the product.

Exposure of the mixture to the carbon dioxide containing feed stream has been found to increase the cure rate and resultant mechanical properties of the product. Furthermore, the resultant construction product has sequestered carbon during accelerated carbonation through exposure to the carbon dioxide containing feed stream. As a result, the product is removing carbon from the atmosphere and locking the carbon within the product indefinitely. Furthermore, when the product incorporates pyrolyzed bio-aggregate, even further carbon is sequestered from the atmosphere and locked away within the product. The manufacturing process has been found to be low-carbon or carbon-negative. The product is therefore an effective carbon dioxide removal product.

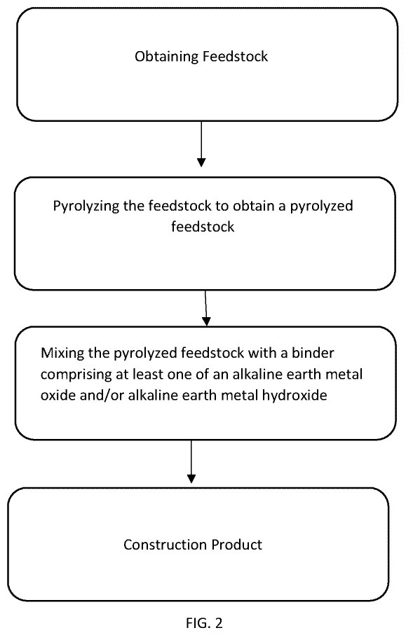

With reference to FIG. 2, feedstock is obtained 201 and further pyrolyzed to obtain pyrolyzed feedstock 202.

The feedstock may be any bio-aggregate disclosed herein. The feedstock may in addition or in the alternative be obtained from pyrolysis of post-consumer and/or post-industrial waste.

Pyrolysis may be carried out by heating the feedstock (for example bio-aggregate) to an elevated temperature of 500° C. or above, in the absence of oxygen. The pyrolysis may comprise heating the feedstock to between 500° C. and 1000° C. The pyrolysis may comprise heating the feedstock to between 500° C. and 800° C. The pyrolysis may comprise heating the feedstock to between 500° C. and 700° C. The feedstock may be heated from substantially room temperature to between 500° C. and 1000° C. in a time period of 5 minutes to 1 hour. The feedstock may be heated from substantially room temperature to between 500° C. and 1000° C. in a time period of 15 minutes to 1 hour. The feedstock may be heated from substantially room temperature to between 500° C. and 800° C. in a time period of 5 minutes to 1 hour. The feedstock may be heated from substantially room temperature to between 500° C. and 800° C. in a time period of 15 minutes to 1 hour. The feedstock may be heated at a temperature ramp rate of between 10° C. per minute and 125° C. per minute, such as 30° C. per minute.

It has been found that feedstock that has been pyrolyzed at higher temperatures is more stable. More stable pyrolyzed feedstock can hold carbon for hundreds more years, thereby slowing the rerelease of carbon into the atmosphere by the construction product.

The pyrolyzed feedstock is then mixed with a binder comprising at least one of: an alkaline earth metal oxide and/or alkaline earth metal hydroxide 203 to form the construction product 204. The mixture may be heated to a predetermined temperature to cure the mixture and form the construction product. Preferably, the mixture is heated to a temperature of at least 25° C.

The mixture comprising the pyrolyzed feedstock may be exposed to a carbon dioxide containing feed stream as described in relation to FIG. 1 above.

Heating of the mixture may be achieved by burning biogas or bio-oil generated from the pyrolysis of the feedstock. The method of the present invention reduces the use of fossil fuel and provides a method of using the resultant product of pyrolysis and thereby efficiently sequestering biogenic carbon, whilst further utilising the heat generated by the pyrolysis process in the manufacturing process of the product.

The construction product incorporates pyrolyzed bio-aggregate, optionally further utilising the bio-oil or bio-gas arising from the pyrolysis for heating, thereby sequestering carbon from the atmosphere and locked away within the product. The manufacturing process for the product of the present invention has been found to be low-carbon or carbon-negative. The product of the present invention is therefore an effective carbon dioxide removal product.

The presence of pyrolyzed feedstock within the mixture has been found to decrease the viscosity of the mixture, thereby reducing the rate of manufacture of the construction product The presence of pyrolyzed feedstock within the product has been found to provide good thermal and hygroscopic properties during the life of the product. The illustration of a particular order to the blocks in FIG. 1 or 2 does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the applicant claims protection in respect of any patentable feature or combination of features hereinbefore referred to and/or shown in the drawings whether or not particular emphasis has been placed thereon.

1. A method of manufacturing a construction product, wherein the construction product is an internal board comprising an accelerated carbonation-cured mixture, the method comprising:
producing a mixture of:
i) at least one of: bio-aggregate or pyrolyzed feedstock; and
ii) a binder, the binder comprising an alkaline earth metal oxide or alkaline earth metal hydroxide;
exposing the mixture to a carbon dioxide containing feed stream for accelerated carbonation of the mixture;
forming the mixture into a predetermined geometric shape; and
providing a planar lining material on one or more outer faces of the predetermined geometric shape.

2. The method as claimed in claim 1, wherein the internal board is an internal lining board.

3. The method as claimed in claim 1, in which the production of the mixture occurs simultaneously with the step of exposing the mixture to a carbon dioxide containing feed stream.

4. The method as claimed in claim 1, in which the step of producing the mixture occurs prior to the step of exposing the mixture to a carbon dioxide containing feed stream.

5. The method as claimed in claim 1, in which the step of forming the mixture into a predetermined geometric shape is conducted prior to and/or during exposure of the mixture to the carbon dioxide containing feed stream.

6. The method as claimed in claim 5, in which the step of forming the mixture into a predetermined geometric shape is conducted prior to exposure of the mixture to the carbon dioxide containing feed stream.

7. The method as claimed in claim 1, in which the carbon dioxide containing feed stream comprises an increased concentration of carbon dioxide compared to atmospheric concentrations.

8. The method as claimed in claim 1, wherein the concentration of carbon dioxide within the carbon dioxide containing feed stream is at least 0.1% by volume.

9. The method as claimed in claim 1, in which the carbon dioxide containing feed stream further comprises water vapour.

10. The method as claimed in claim 1, in which the carbon dioxide containing feed stream is obtained from waste gases from one or more industrial processes.

11. (canceled)

12. (canceled)

13. The method as claimed in claim 1, further comprising monitoring and controlling humidity during the step of exposing the mixture to carbon dioxide containing feed stream.

14-21. (canceled)

22. The method as claimed in claim 1, wherein the planar lining material is paper.

23. (canceled)

24. The method as claimed in claim 1, in which the ratio of the amount of bio-aggregate or pyrolyzed feedstock (wt. %) to the amount of binder (wt. %) within the mixture is between 1:6 and 1:3.

25-27. (canceled)

28. The method as claimed in claim 1, in which the mixture is formed into the predetermined geometric shape using extrusion moulding.

29. (canceled)

30. A construction product, wherein the construction product is an internal board and comprises an accelerated carbonation-cured mixture of:
i) a binder comprising at least one of: an alkaline earth metal oxide and/or alkaline earth metal hydroxide; and
ii) bio-aggregate or pyrolyzed feedstock,
wherein planar lining material is provided on one or both outer faces of the mixture.

31-47. (canceled)

48. The method as claimed in claim 1, wherein the mixture comprises pyrolyzed feedstock and the method further comprises pyrolyzing bio-aggregate to provide the pyrolyzed feedstock.

49. A method of manufacturing an internal lining board comprising an accelerated carbonation-cured mixture, comprising:
producing a mixture of:
i) at least one of: bio-aggregate or pyrolyzed feedstock; and
ii) a binder, the binder comprising an alkaline earth metal oxide or alkaline earth metal hydroxide;
combining the mixture with planar lining paper, such that the mixture is located between two opposed sheets of planar lining paper; and
exposing the mixture to a carbon dioxide containing feed stream for accelerated carbonation of the mixture.

50. The method as claimed in claim 49, further comprising forming the mixture into a planar shaped mixture and wherein the step of combining the mixture with the planar lining paper comprises providing the planar lining paper on each outer face of a pair of opposed outer faces of the planar shaped mixture.

51. The method as claimed in claim 49, wherein the step of combining the mixture with the planar lining paper comprises pumping the mixture in-between the two opposed sheets of planar lining paper on a conveyor between rollers.

52. The method as claimed in claim 49, wherein the step of combining the mixture with the planar lining paper comprises applying the mixture to a sheet of the planar lining paper and applying a further sheet of the planar lining paper on an opposed surface of the mixture.
